(19) United States
(12) Patent Application Publication
(10) Pub. No.: US 2026/0279903 A1
(43) Pub. Date: Sep. 17, 2026

(54) ELECTROLYTE AND USE THEREOF IN AN ELECTROCHEMICAL CELL

(71) Applicant: ILIKA TECHNOLOGIES LTD, Romsey Hampshire (GB)

(72) Inventors: Donato Ercole CONTE, Romsey Hampshire (GB); Robert BRADLEY, Romsey Hampshire (GB)

(73) Assignee: ILIKA TECHNOLOGIES LTD, Romsey Hampshire (GB)

(21) Appl. No.: 19/473,543

(22) PCT Filed: Apr. 26, 2024
(86) PCT No.: PCT/GB2024/051115

§ 371 Date: Oct. 8, 2025

(30) Foreign Application Priority Data
Apr. 28, 2023 (GB) 2306375.3

(51) Int. Cl. H01M 10/0565; H01M 10/0525

(52) U.S. Cl. CPC H01M 10/0565; H01M 10/0525; H01M 2300/0025

(57) ABSTRACT

A gel polymer electrolyte comprises a polymer matrix and a liquid electrolyte that is trapped and retained within the polymer matrix. The polymer matrix is provided by a copolymer that comprises linear polymer chains having a monofunctional repeating unit and crosslinkers that provide a polymeric cross-linking function between the linear chains.

### FIELD OF THE INVENTION

The present invention relates to electrolytes and their use in electrochemical cells.

### BACKGROUND TO THE INVENTION

A lithium-ion battery cell is a type of rechargeable battery cell having two electrodes that are each capable of reversibly storing lithium ions (Li⁺). During discharge of the cell, lithium ions move from the negative electrode (anode) to the positive electrode (cathode), and the direction is reversed when the cell is charged.

It is necessary for the two electrodes to be kept apart, to avoid short circuits. At the same time, ionic transport between the electrodes must be facilitated, so that the internal resistance of the cell is held at acceptable levels.

In certain cells, the electrodes are held apart by a separator, such as a porous polymer membrane, while the ion-conducting medium is provided by a liquid electrolyte. However, in this arrangement, there is a risk that the liquid electrolyte may leak.

Alternatively, a layer of ceramic electrolyte may be provided between the electrodes. The ceramic electrolyte typically comprises sintered particles of a ceramic ion-conducting material. However, the interfacial resistance between the particles tends to be high, resulting in low ionic transfer rates between the particles, thus increasing the internal resistance of the battery.

In a further alternative, a polymer electrolyte may be provided between the two electrodes: this may comprise, for example, poly(ethylene oxide) that has lithium ions distributed throughout the polymer network.

It is generally desirable to provide improved electrolyte materials that reduce the internal resistance of the battery and/or increase the safety of the battery.

Typically, Li-ion battery cells include additional components such as current collectors and/or encapsulations or other protective elements. In certain cases, the negative electrode is not present in the battery cell immediately after assembly of the cell, but is instead provided as a lithium metal anode formed during initial charging of the battery cell.

Rechargeable battery cells are also known that use other charge-carrying metal ions in place of Li⁺ ions, for example, rechargeable battery cells are known that comprise Na⁺ or Mg²⁺ as the charge-carrying metal ions.

### SUMMARY OF THE INVENTION

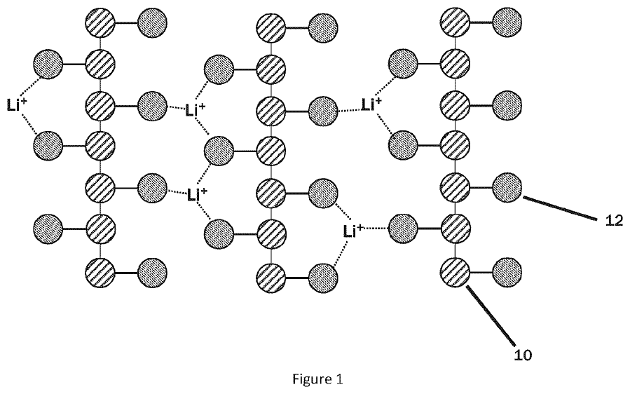

In the case of certain polymer gel electrolytes, such as those based on poly(ethylene oxide) or ethylene glycol phenyl ether acrylate (EGPEA), it is thought that Li⁺ ions (or other charge-carrying metal ions) play a role in linking polymer chains, due to the interaction of the Li⁺ ions with electronegative functional groups on the chains (see, for example, FIG. 1 showing a polymer gel electrolyte based on EGPEA, which has a primary acrylate chain 10 and electronegative ethylene glycol functional groups 12. Li⁺ ions assist in linking the polymer chains through their interaction with the ethylene glycol groups). This generally has the effect of hindering the movement of Li⁺ ions through the polymer gel electrolyte, thus reducing its ionic conductivity.

In other polymer gel electrolytes, polymer chains may be linked through polymeric crosslinking. However, it has been found that if the extent of crosslinking is too high, the movement of Li⁺ ions will also be impeded.

Therefore, at its most general, the present invention may provide a gel polymer electrolyte in which polymer chains are at least partly linked through polymeric crosslinking, but the extent of polymeric crosslinking is low enough so as not to provide an excessive barrier to the movement of the charge-carrying metal ions of an electrochemical cell.

In a first aspect, the present invention may provide a gel polymer electrolyte comprising a polymer matrix and a liquid electrolyte that is trapped and retained within the polymer matrix, wherein the polymer matrix is provided by a copolymer that comprises linear polymer chains having a monofunctional repeating unit and crosslinkers that provide a polymeric cross-linking function between the linear polymer chains.

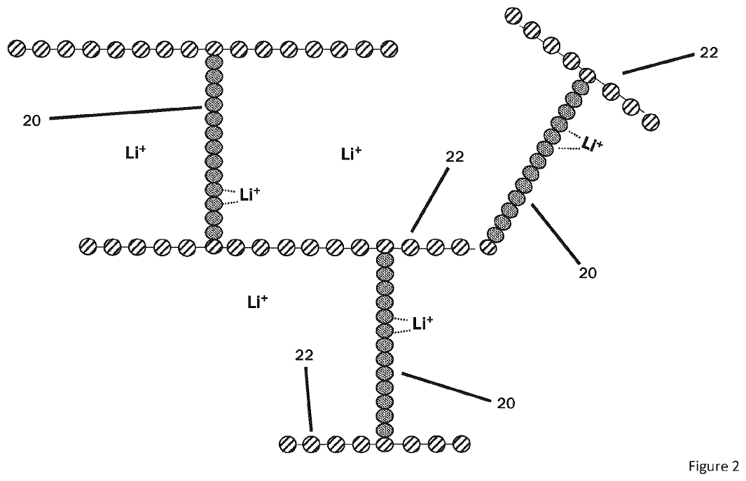

As used herein, the term “linear polymer chain having a monofunctional repeating unit” refers to a linear polymer chain that is formed through the polymerisation of monomers each having a single polymerisable group, that is, monomers that each form bonds to no more than two other monomers during the polymerisation process. It is thought that a copolymer comprising these linear polymer chains will have an open structure that allows relatively unimpeded movement of charge-carrying metal ions such as Li⁺ ions. An example of this type of open structure is shown schematically in FIG. 2, which shows linear acrylate chains 22 that are linked by diacrylate crosslinkers 20.

The linear polymer chains may themselves be copolymers, provided that they are formed through the polymerisation of monomers having a single polymerisable group.

In general, the molar ratio of the monofunctional repeating unit and the crosslinkers lies in the range 50:50-99.9:0.1, preferably in the range 80:20 to 99:1, more preferably in the range 85:15 to 98:2. This is considered to provide a preferred level of crosslinking in the polymer network.

In general, the ratio of the total mass of the linear chains having a monofunctional repeating unit and the total mass of the crosslinkers lies in the range 30:70 to 95:5. In certain cases, the ratio of the total mass of the linear chains having a monofunctional repeating unit and the total mass of the crosslinkers lies in the range 40:60 to 90:10. In certain cases, the ratio of the total mass of the linear chains having a monofunctional repeating unit and the total mass of the crosslinkers lies in the range 50:50 to 85:15.

Typically, the polymer matrix is present in an amount of 1-70 vol % relative to the total volume of the gel polymer electrolyte, preferably 2-40 vol %, more preferably 4-20 vol %.

In general, the polymer matrix is present in an amount of 1-25 wt % relative to the total mass of the gel polymer electrolyte. In certain cases, the polymer matrix is present in an amount of 2-20 wt % relative to the total mass of the gel polymer electrolyte. In certain cases, the polymer matrix is present in an amount of 3-15 wt % relative to the total mass of the gel polymer electrolyte.

The extent of crosslinking of the polymer network may be characterised through the determination of the storage modulus of the polymer. Therefore, it is preferred that the gel polymer electrolyte has a storage modulus G′ of 10-950 Pa at a frequency of 0.1 rad/s, more preferably 20-800 Pa at a frequency of 0.1 rad/s, most preferably 40-750 Pa at a frequency of 0.1 rad/s.

The length of the polymeric crosslinkers generally affects the extent of separation of neighbouring linear polymer chains, and hence affects the extent to which charge-carrying metal ions such as Li⁺ are able to move freely through the gel polymer. Therefore, it is preferred that the polymeric crosslinkers have a molecular weight (that is, a weight-averaged molecular weight) in the range 170-6000 Mw, more preferably 170-4000 Mw, most preferably 170-2000 Mw. The weight-averaged molecular weight may be determined using the protocol set out in ISO 16014-2:2019.

In general, at least 90% by weight of the polymeric crosslinkers have reactive ends that are selected from the group consisting of acrylic or methacrylic functional groups. In certain cases, at least 95% by weight of the polymeric crosslinkers have reactive ends that are selected from the group consisting of acrylic or methacrylic functional groups. In certain cases, at least 99% by weight of the polymeric crosslinkers have reactive ends that are selected from the group consisting of acrylic or methacrylic functional groups.

Typically, at least 90% by weight of the polymeric crosslinkers comprise a main chain and at least two reactive ends, wherein the main chain comprises a unit selected from the group consisting of: alkane, polyethylene oxide (glycol), polypropylene oxide, bisphenol A ethoxylate, and siloxane. In certain cases, at least 95% by weight of the polymeric crosslinkers have this configuration. In certain cases, at least 99% by weight of the polymeric crosslinkers have this configuration.

In certain cases, at least 95% by weight of the polymeric crosslinkers have exactly two reactive ends. This is thought to limit the extent of crosslinking in the polymer gel, so as to reduce any barrier to the movement of charge-carrying metal ions, such as Li⁺. In certain cases, at least 97% by weight of the polymeric crosslinkers have exactly two reactive ends.

In certain cases, at least 99% by weight of the polymeric crosslinkers have exactly two reactive ends.

Typically, at least 90% by weight of the polymeric crosslinkers are selected from the group consisting of: poly(ethylene glycol) diacrylate; poly(propylene glycol) diacrylate; bisphenol A ethoxylate diacrylate; 1,10-bis(acryloyloxy) decane; polyethyleneglycol dimethacrylate; organopolysiloxane dimethacrylate, and combinations thereof. In certain cases, at least 95% by weight of the polymeric crosslinkers are selected from this group. In certain cases, at least 99% by weight of the polymeric crosslinkers are selected from this group.

In certain embodiments, at least 90% by weight of the polymeric crosslinkers are poly(ethylene glycol) diacrylate. In certain embodiments, at least 95% by weight of the polymeric crosslinkers are poly(ethylene glycol) diacrylate. In certain embodiments, at least 99% by weight of the polymeric crosslinkers are poly(ethylene glycol) diacrylate.

In certain embodiments, at least 90% by weight of the monofunctional repeating units of the linear polymer chains are acrylate or methacrylate units. In certain embodiments, at least 95% by weight of the monofunctional repeating units of the linear polymer chains are acrylate or methacrylate units. In certain embodiments, at least 99% by weight of the monofunctional repeating units of the linear polymer chains are acrylate or methacrylate units.

Typically, at least 90% by weight of the monofunctional repeating units of the linear polymer chains comprise an alkane chain consisting of 1-8 carbon atoms. It is thought that repeating units having longer alkane chains may be less compatible with the liquid electrolyte. In certain cases, at least 95% by weight of the monofunctional repeating units of the linear polymer chains comprise an alkane chain consisting of 1-8 carbon atoms. In certain cases, at least 99% by weight of the monofunctional repeating units of the linear polymer chains comprise an alkane chain consisting of 1-8 carbon atoms.

Typically, at least 90% by weight of the monofunctional repeating units of the linear polymer chains is selected from the group consisting of: methyl acrylate, ethyl acrylate, butyl acrylate, hexyl acrylate, 2-ethyl hexyl acrylate, benzyl acrylate, methyl methacrylate, butyl methacrylate, trifluoroethyl acrylate, hexyl methacrylate, and combinations thereof. In certain cases, at least 95% by weight of the repeating units are selected from this group. In certain cases, at least 99% by weight of the repeating units are selected from this group.

Typically, at least 90% by weight of the monofunctional repeating units of the linear polymer is provided by the following unit:

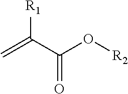

Wherein R₁ is H or CH₃; and R₂ is an alkane chain having 1-8 C.

In certain cases, at least 95% by weight of the monofunctional repeating units of the linear polymer is provided by this unit. In certain cases, at least 99% by weight of the monofunctional repeating units of the linear polymer is provided by this unit.

The choice of liquid electrolyte is not particularly limited. Typically, the liquid electrolyte comprises a solution of a lithium, sodium, or magnesium salt in a non-aqueous solvent. In certain cases, the solvent is aprotic.

Typically, the molar ratio of the electrolyte salt (that is, the lithium, sodium, or magnesium salt) and the monofunctional repeating unit lies in the range 0.2:1 to 4:1. In certain cases, the molar ratio lies in the range 0.3:1 to 3:1.

Preferably, the solvent is a polar solvent. In certain cases, the solvent is a carbonate solvent, for example, a solvent selected from the list consisting of: ethylene carbonate, dimethyl carbonate, ethyl methyl carbonate, fluoroethyl methyl carbonate, fluoroethylene carbonate, diethyl carbonate, propylene carbonate, vinylene carbonate, and mixtures thereof.

Typically, the liquid electrolyte comprises a lithium, sodium, or magnesium salt having an anion that has a volume in the range 0.03-0.55 nm³ in its desolvated state.

In the case that the liquid electrolyte comprises a solution of a lithium salt, the lithium salt is typically selected from the group consisting of LiPF₆, LiCIO₄, LiBr, LiNO₃, lithium sulfonylimide salts, lithium borate salts and mixtures thereof.

In a preferred embodiment, the liquid electrolyte comprises a solution of LiPF₆ and/or lithium bis(trifluoromethanesulfonyl)imide (LiTFSI).

In a second aspect, the present invention may provide an electrochemical cell comprising at least an electrode layer and an electrolyte layer disposed on a face of the electrode layer, wherein the electrolyte layer comprises a gel polymer electrolyte according to the first aspect of the invention.

For the avoidance of doubt, the term “electrolyte layer” refers to the component of the electrochemical cell that has the function of separating the anode and cathode of the electrochemical cell (as discussed in the Background to the Invention, the anode may be present immediately after assembly of the cell or it may be formed during initial charging of the cell). As such, the electrolyte layer has the function of allowing the movement of ions across its thickness, but inhibiting the movement of electrons, and is free from electrode active material. The electrolyte layer comprises ionically-conductive components, but may additionally comprise other components that are not ionically-conductive.

In certain cases, the electrolyte layer further comprises a porous spacer, wherein the porous spacer optionally comprises a material selected from the group consisting of: polymeric materials (for example, polyethylene); electrically-insulating materials; and a composite material having a polymeric matrix and additionally comprising ceramic electrolyte particles.

In certain cases, the electrolyte layer further comprises a plurality of ceramic electrolyte particles that are connected to provide a self-supporting network, the gel polymer electrolyte being present in at least a portion of the interstices between the ceramic electrolyte particles. The self-supporting network of ceramic electrolyte particles may assist in providing the electrolyte layer with a defined minimum thickness, such that a defined minimum separation is maintained between opposing faces of the electrolyte layer. This may assist in avoiding short circuits across the electrolyte layer.

The self-supporting network in which the ceramic electrolyte particles are arranged may be a sintered porous ceramic body. In certain cases, adjacent ceramic electrolyte particles are in direct bonded contact, for example, direct sintered contact. In other cases, adjacent ceramic electrolyte particles are bonded by a different ceramic phase that may be provided by an inorganic sintering aid.

The choice of the material of the ceramic electrolyte particles is not particularly limited. Preferably, the ceramic electrolyte particles have an ionic conductivity greater than 10⁻⁶ S cm⁻¹. More preferably, the ceramic electrolyte particles have an ionic conductivity greater than 10⁻⁴ S cm⁻¹. Still more preferably, the ceramic electrolyte particles have an ionic conductivity greater than 10⁻³ S cm⁻¹. The ionic conductivity of the ceramic electrolyte particles may be determined through analysis of the Nyquist plot obtained through electrochemical impedance spectroscopy at 25° C. of the material of the ceramic electrolyte particles when provided in bulk form.

Typically, the ceramic electrolyte particles comprise a lithium-containing electrolyte material. For example, the ceramic electrolyte particles may comprise a lithium garnet electrolyte material. In certain cases, the ceramic electrolyte particles may comprise a lithium oxide material. For example, the ceramic electrolyte particles may comprise a material selected from the group consisting of: lithium lanthanum zirconium oxide (LLZO) and cation-doped LLZO, wherein the cation dopant may be selected from the group consisting of tantalum, barium, yttrium, zinc, niobium, aluminium, germanium, strontium, gallium, titanium, and combinations thereof. The electrolyte material may have the formula Li₇₋ₓLa₃Zr₂₋ₓMₓO₁₂, wherein 0<x<1 and M is selected from the group consisting of Ta, Ba, Y, Zn, Nb, Al, Ge, Sr, Ga, Ti, and combinations thereof. In certain cases, M is Nb or Ta.

In the case that the self-supporting network comprises an inorganic sintering aid in addition to the plurality of ceramic electrolyte particles, the inorganic sintering aid has a melting point lower than that of the ceramic electrolyte particles. The inorganic sintering aid typically has a melting point of 900° C. or less. In certain cases, the inorganic sintering aid has a melting point of 850° C. or less, for example, 800° C. or less or 750° C. or less. In certain cases, the melting point of the inorganic sintering aid is 700° C. or less.

The melting point of the inorganic sintering aid may be measured through differential scanning calorimetry of the inorganic sintering aid when provided in bulk form.

When present, the inorganic sintering aid is typically provided by an ion conductive material having an ionic conductivity greater than 10⁻¹⁰ S cm⁻¹. In certain cases, the inorganic sintering aid is provided by an ion conductive material having an ionic conductivity greater than 10⁻⁹ S cm⁻¹. In certain cases, the inorganic sintering aid is provided by an ion conductive material having an ionic conductivity greater than 10⁻⁸ S cm⁻¹. In certain cases, the inorganic sintering aid is provided by an ion conductive material having an ionic conductivity greater than 10⁻⁷ S cm⁻¹. In certain cases, the inorganic sintering aid is provided by an ion conductive material having an ionic conductivity greater than 10⁻⁶ S cm⁻¹. In certain cases, the inorganic sintering aid is provided by an ion conductive material having an ionic conductivity that is lower than that of the ceramic electrolyte particles.

The ionic conductivity of the inorganic sintering aid may be determined through analysis of the Nyquist plot obtained through electrochemical impedance spectroscopy at 25° C. of the material of the inorganic sintering aid when provided in bulk form.

The sintering aid may comprise a compound selected from the group consisting of oxides, carbonates (including Li₂CO₃), hydrides (including LiBH₄), halides (including LiF, LiCl, LiBr, and LiI), silicates (including Li₂—SiO₂), alkali metal hydroxides (such as LiOH), and mixtures thereof.

In certain cases, the sintering aid may comprise eutectic mixtures of materials, such as LiOH—NaOH eutectic.

In certain cases, the sintering aid may comprise lithium, boron, and optionally carbon as component elements. For example, the sintering aid may comprise Li₃BO₃ (Li₃BO₃ has been shown to have an ionic conductivity of about 6.0×10⁻⁸ S/cm and a melting point of about 800° C.).

In certain cases, the sintering aid may comprise Li₃₋ₓB₁₋ₓCₓO₃, wherein 0<x<1. Li_{2.2}C_{0.8}B_{0.2}O₃, for example, has been shown to have an ionic conductivity of about 8.0×10⁻⁷ S/cm and a melting point of about 685° C. Li₃₋ₓB₁₋ₓCₓO₃ (wherein 0.5<x<0.99) has been shown to have a melting point in the range 680° C. to 750° C.

The inorganic sintering aid is typically present in an amount of 1-40 wt % relative to the total amount of inorganic solids in the electrolyte layer. In certain cases, the inorganic sintering aid is present in an amount of 5-35 wt % relative to the total amount of inorganic solids in the electrolyte layer. In certain cases, the inorganic sintering aid is present in an amount of 10-30 wt % relative to the total amount of inorganic solids in the electrolyte layer.

For the avoidance of doubt, the inorganic sintering aid is a solid at 25° C.

Preferably, in the case that the electrolyte layer comprises a plurality of ceramic electrolyte particles that are connected to provide a self-supporting network, the total amount of solid, inorganic material in the electrolyte layer is 60 vol % or less relative to the total volume of the electrolyte layer. This is thought to improve the extent of penetration of the gel polymer electrolyte into the interstices between the ceramic electrolyte particles.

In such cases, the total amount of solid, inorganic material present in the electrolyte layer may be 55 vol % or less relative to the total volume of the electrolyte layer, and in certain cases, 50 vol % or less relative to the total volume of the electrolyte layer.

Preferably, the amount of solid, inorganic material present in the electrolyte layer is at least 30 vol % relative to the total volume of the electrolyte layer, to help ensure that short circuits across the electrolyte layer are prevented.

In general, the total amount of solid, inorganic material present in the electrolyte layer lies in the range 30-60 vol % relative to the total volume of the electrolyte layer. In certain cases, the total amount of solid, inorganic material present in the electrolyte layer lies in the range 35-60 vol % relative to the total volume of the electrolyte layer. In certain cases, the total amount of solid, inorganic material present in the electrolyte layer lies in the range 40-55 vol % relative to the total volume of the electrolyte layer.

Preferably, the electrolyte layer has a thickness of 100 μm or less. This is thought to assist in reducing the internal resistance of the electrochemical cell. More preferably, the electrolyte layer has a thickness of 60 μm or less. Most preferably, the electrolyte layer has a thickness of 40 μm or less.

In certain cases, the electrolyte layer has a thickness in the range 5-100 μm. In certain cases, the electrolyte layer has a thickness in the range 5-60 μm. In certain cases, the electrolyte layer has a thickness in the range 5-40 μm. In certain cases, the electrolyte layer has a thickness in the range 10-40 μm.

Typically, the electrode layer comprises electrode active particles. In general, the gel polymer electrolyte is additionally present in at least a portion of the interstices between the electrode active particles.

Thus, the gel polymer electrolyte may additionally assist in enhancing ion conduction in the electrode layer.

The electrode active particles comprise an electrode active material.

The electrode layer may further comprise ceramic electrolyte particles. These particles generally have the properties discussed above in relation to the ceramic electrolyte particles that may be present in the electrolyte layer. In certain cases, the electrode layer may comprise the same ceramic electrolyte particles as the electrolyte layer. However, in other cases, the electrode layer may comprise ceramic electrolyte particles that are different from those optionally present in the electrolyte layer.

Typically, the electrode active particles and any optional ceramic electrolyte particles are connected to provide a self-supporting network. This self-supporting network may be a sintered porous ceramic body. In certain cases, adjacent electrode active particles and/or ceramic electrolyte particles are in direct bonded contact, for example, direct sintered contact. In other cases, adjacent electrode active particles and/or ceramic electrolyte particles are bonded by a different ceramic phase that may be provided by an inorganic sintering aid.

When present, the inorganic sintering aid generally has the properties discussed above in relation to the optional inorganic sintering aid of the electrolyte layer. In certain cases, the electrode layer may comprise the same inorganic sintering aid as the electrolyte layer. However, in other cases, the electrode layer may comprise an inorganic sintering aid that is different from any inorganic sintering aid in the electrolyte layer.

Preferably, the total volume of solid, inorganic material (including electrode active particles, any optional ceramic electrolyte particles and any optional inorganic sintering aid) within the electrode layer is 80% or less of the total volume of the electrode layer. This is thought to promote penetration of the gel polymer electrolyte into the electrode, due to the volume of unoccupied space around the electrode active particles and any optional ceramic electrolyte particles.

In certain cases, the total volume of solid, inorganic material within the electrode layer is 70% or less of the total volume of the electrode layer. In certain cases, the total volume of solid, inorganic material within the electrode layer is 60% or less of the total volume of the electrode layer.

If the total amount of solid, inorganic material (including electrode active particles, any optional ceramic electrolyte particles and any optional inorganic sintering aid) in the electrode is too low, then it is likely that the energy density of the cell will be adversely affected. Thus, it is preferred that the total volume of solid, inorganic material within the electrode layer is at least 40% of the total volume of the electrode layer.

In certain cases, the total volume of solid, inorganic material within the electrode layer is at least 45% of the total volume of the electrode layer. In certain cases, the total volume of solid, inorganic material within the electrode layer is at least 50% of the total volume of the electrode layer. In certain cases, the total volume of solid, inorganic material within the electrode layer is at least 55% of the total volume of the electrode layer.

Typically, the total volume of solid, inorganic material within the electrode layer is 40-80% of the total volume of the electrode layer. In certain cases, the total volume of solid, inorganic material within the electrode layer is 45-75% of the total volume of the electrode layer. In certain cases, the total volume of solid, inorganic material within the electrode layer is 50-70% of the total volume of the electrode layer.

Typically, the electrode layer has a thickness of at least 10 μm. Preferably, the electrode layer has a thickness of at least 20 μm. This is thought to assist in increasing the energy density of the electrochemical cell.

In certain cases, the electrode layer has a thickness of 10-100 μm. In certain cases, the electrode layer has a thickness of 10-80 μm. In certain cases, the electrode layer has a thickness of 20-50 μm.

In certain cases, the electrode layer is a cathode layer.

In such cases, the electrode typically comprises a cathode active material having a potential that is less than 5V vs Li/Li⁺, measured at an ambient temperature of 25° C. and an ambient pressure of 1 atmosphere. This is preferred, as the operation of the cell at higher potentials may damage the gel polymer electrolyte. Examples of cathode active materials having the specified potential are lithium iron phosphate; lithium cobalt oxide; lithium nickel manganese oxide; nickel cobalt aluminium oxide; LiNiₓMn_{y}Co_{1-x-y}O₂ (wherein x=0.25-0.4 and y=0.25-0.4); and mixtures thereof.

In such cases, the electrochemical cell typically also comprises an anode layer, the anode layer being disposed on a face of the electrolyte layer that is distal to the cathode layer. The anode layer may comprise graphite, silicon, or lithium metal. Preferably, the anode layer comprises graphite or silicon.

In certain cases, the anode is not present in the cell immediately after assembly of the cell, but is instead provided as a lithium metal anode formed during initial charging of the cell. In such cases, immediately after assembly, the cell may comprise a current collector layer that is in direct contact with the face of the electrolyte layer that is distal to the cathode. The current collector layer may be provided by a sheet of metal, such as a sheet of copper or a copper alloy.

In certain cases, the electrolyte layer may comprise a thin layer of excess gel polymer electrolyte that is present at the face of the electrolyte layer that is distal from the cathode. This layer may assist in providing adhesion between the electrolyte layer and the layer that is immediately adjacent to it (for example, the anode layer or the current collector layer). The layer of excess gel polymer electrolyte typically has a thickness of 0.5-5 μm.

In a third aspect, the present invention may provide a precursor composition for forming a gel polymer electrolyte according to the first aspect of the invention, the precursor composition comprising:
a quantity of monofunctional monomers;
a quantity of crosslinker molecules, the crosslinker molecules having at least two reactive ends;
a liquid electrolyte; and
optionally, a polymerisation initiator.

The term “monofunctional monomer” refers to a monomer having a single polymerisable group, that is, a monomer that forms bonds to no more than two other monomers during polymerisation.

Typically, the molar ratio of the monofunctional monomers and the crosslinker molecules lies in the range 50:50 to 99.9:0.1, preferably in the range 80:20 to 99:1, more preferably in the range 85:15 to 98:2.

In general, the quantity of monofunctional monomers comprises acrylate or methacrylate monomers, which may be selected from the group consisting of: methyl acrylate, ethyl acrylate, butyl acrylate, hexyl acrylate, 2-ethyl hexyl acrylate, benzyl acrylate, methyl methacrylate, butyl methacrylate, trifluoroethyl acrylate, hexyl methacrylate, and combinations thereof.

In certain cases, the quantity of monofunctional monomers comprises at least 90% acrylate or methacrylate monomers by weight. In certain cases, the quantity of monofunctional monomers comprises at least 95% acrylate or methacrylate monomers by weight. In certain cases, the quantity of monofunctional monomers comprises at least 99% acrylate or methacrylate monomers by weight.

In general, at least 90% by weight of the monomers comprise an alkane chain consisting of 1-8 carbon atoms. In certain cases, at least 95% by weight of the monomers comprise an alkane chain consisting of 1-8 carbon atoms. In certain cases, at least 99% by weight of the monomers comprise an alkane chain consisting of 1-8 carbon atoms.

Typically, the polymerisation initiator is a thermal polymerisation initiator. For example, the polymerisation initiator may be a thermal radical polymerisation initiator, such as 2,2′-azobis(isobutyronitrile) (AIBN) or benzoyl peroxide.

In a fourth aspect, the present invention may provide a method of making a gel polymer electrolyte according to the first aspect of the invention, comprising providing a precursor composition according to the third aspect of the invention and curing the precursor composition.

Typically, the step of providing a precursor composition according to the third aspect of the invention comprises physically combining the quantity of monofunctional monomers, the quantity of crosslinker molecules, the liquid electrolyte and the polymerisation initiator (if this is being used) within a time period of 30 minutes or less, preferably 20 minutes or less, more preferably 10 minutes or less.

Typically, the step of curing the precursor composition comprises heating the composition, for example to a temperature in the range 40-70° C.

During the curing step, the monofunctional monomers polymerise to provide the linear polymer chains, and the crosslinker molecules provide the polymeric crosslinking function between the linear chains. Typically, the polymerisation process is a thermal polymerisation process.

In a fifth aspect, the present invention may provide a method of making an electrochemical cell according to the second aspect of the invention, comprising the steps of providing a substrate comprising an electrode active material; applying a precursor composition according to the third aspect of the invention to an exposed surface of the substrate; and curing the precursor composition to provide a gel polymer electrolyte.

The substrate may comprise at least a first layer and a second layer that are in a stacked arrangement, wherein:
the electrode active material is provided in the first layer; and
the second layer is free of electrode active material, comprises a plurality of ceramic electrolyte particles that are connected to provide a self-supporting network, and provides the exposed surface of the substrate.

### DETAILED DESCRIPTION

The invention will now be described by way of example with reference to the following Figures in which:

FIG. 1 shows a schematic representation of the molecular structure of a Comparative Example of a polymer gel electrolyte;

FIG. 2 shows a schematic representation of the molecular structure of a polymer gel electrolyte according to an embodiment of the first aspect of the invention;

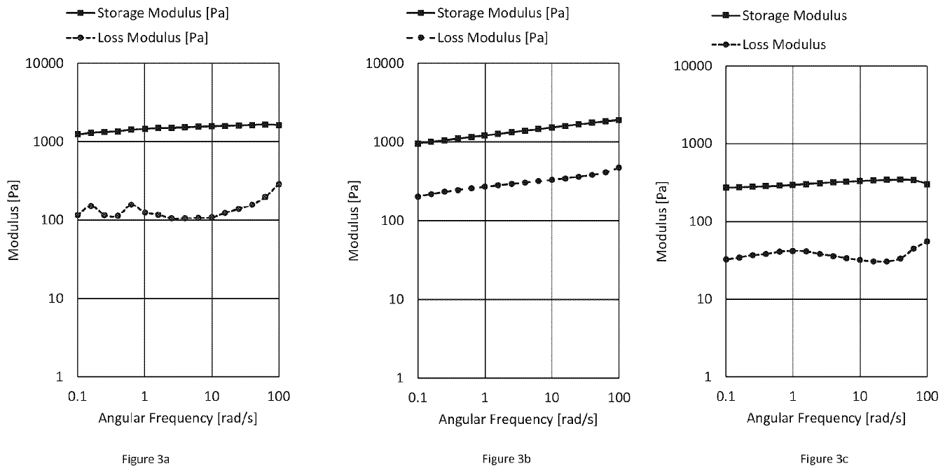

FIG. 3a shows a graph of storage modulus and loss modulus as a function of angular frequency for a first Comparative Example of a polymer gel electrolyte;

FIG. 3b shows a graph of storage modulus and loss modulus as a function of angular frequency for a second Comparative Example of a polymer gel electrolyte;

FIG. 3c shows a graph of storage modulus and loss modulus as a function of angular frequency for a polymer gel electrolyte according to another embodiment of the first aspect of the invention;

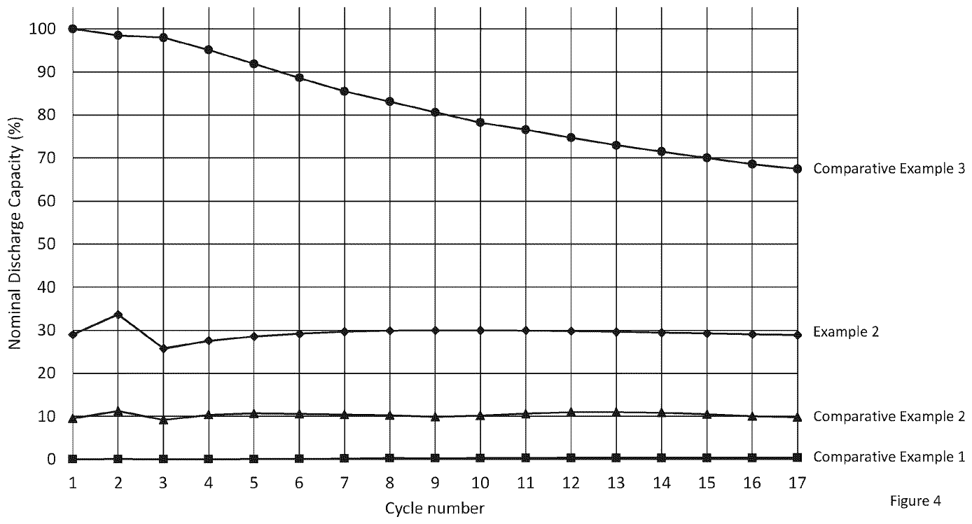

FIG. 4 shows the change in nominal discharge capacity with cycle number during electrochemical cycling of battery cells comprising different forms of electrolyte.

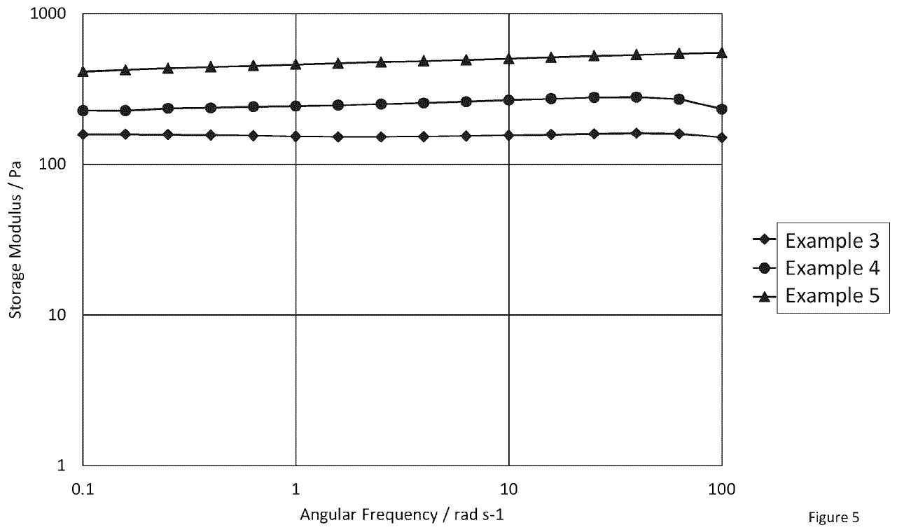

FIG. 5 shows a graph of storage modulus as a function of angular frequency for polymer gel electrolytes having different levels of crosslinking.

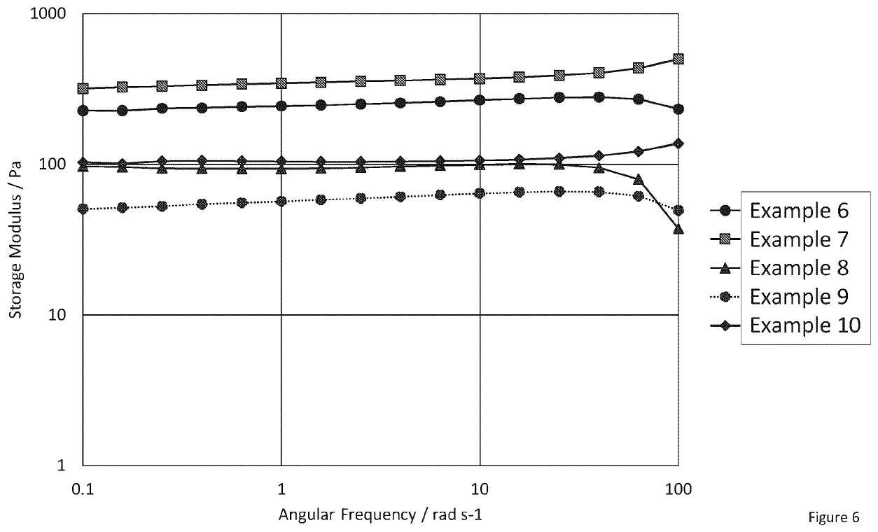

FIG. 6 shows a graph of storage modulus as a function of angular frequency for polymer gel electrolytes having different crosslinker types

### PREPARATION OF THE POLYMER GEL PRECURSOR

Polymer gel precursors were prepared by mixing the ingredients listed in Table 1.

The PEGDA cross-linker monomer of Examples 1 and 2 had a number-averaged molecular weight (Mn) of 700.

TABLE 1

| | | | Comparative | Comparative |
|---|---|---|---|---|
| | Example 1 | Example 2 | Example 1 | Example 2 |
| Liquid | 7.2 g 1M | 7.2 g 1M | 7.2 g 1M | 7.2 g 1M |
| electrolyte | solution of | solution of | solution of | solution of |
| | LiPF₆ in a | LiPF₆ in a | LiPF₆ in a | LiPF₆ in a |
| | carbonate | carbonate | carbonate | carbonate |
| | solvent | solvent | solvent | solvent |
| Monofunc- | 0.34 g Butyl | 0.338 g Ethyl | 1.7 g | Not used |
| tional | acrylate | acrylate | Ethylene | |
| monomer | | | glycol | |
| | | | phenyl ether | |
| | | | acrylate | |
| | | | (EGPEA): | |
| | | | 100 wt % | |
| Crosslinker | 0.165 g | 0.18 g | Not used | 0.12 g |
| monomer | Polyethylene | Polyethylene | | Pentaeryth- |
| | glycol | glycol | | ritol |
| | diacrylate | diacrylate | | tetraacrylate |
| | (PEGDA) | (PEGDA) | | (PENTA) |
| Polymeri- | 0.005 g | 0.005 g | 0.005 g | 0.007 g |
| sation | Azobisiso- | Azobisiso- | Azobisiso- | Azobisiso- |
| initiator | butyronitrile | butyronitrile | butyronitrile | butyronitrile |
| | (AIBN) | (AIBN) | (AIBN) | (AIBN) |

### Rheological Testing

Gels were prepared by casting the precursors of Example 1 and the Comparative Examples 1 and 2 in a steel dish having a diameter of 55 mm and curing them in an oven at 55° C. for 60 minutes. After cooling to room temperature, rheological testing of the gels was carried out in a rotational rheometer (in this case, the MCR 302 model from Anton Paar).

The procedure was as follows: the dish containing the cured gel was clamped onto the rotational rheometer and a stainless steel upper parallel plate having a diameter of 50 mm was lowered onto the sample surface to achieve a steady state force of 0.25N. Oscillatory rheological measurements were carried out to measure the moduli of the films as a function of shear strain (Amplitude Sweep test) and as a function of frequency (Frequency Sweep test).

Amplitude Sweep: The linear viscoelastic region (LVR) of all samples was determined with an amplitude sweep at incremental shear strains (0.1 to 1000%) and a fixed frequency of 10 Hz.

Frequency sweep testing was performed subsequently after identifying the appropriate stress and strain values, which were within the field of LVR for each sample.

Frequency Sweep: Frequency sweep measurements of film samples were carried out at decreasing oscillating frequencies from 100 to 0.1 rad/s Hz. The mean elastic modulus (G′: also referred to as the storage modulus) and viscous modulus (G″: also referred to as the loss modulus) were plotted against frequency.

All tests were performed at 25±0.1° C.

The results of the frequency sweep tests are shown in FIG. 3a (Comparative Example 1), FIG. 3b (Comparative Example 2), and FIG. 3c (Example 1). From a comparison of FIGS. 3a and 3b with FIG. 3c, it can be seen that the gels of Comparative Examples 1 and 2 are stiffer than the gel of Example 1.

### Preparation of Electrochemical Cells

Electrochemical cells were prepared for Example 2 and Comparative Examples 1 and 2, as follows:
A separator was provided by two stacked circular sheets of filter paper having a diameter of 13 mm (Whatman filter type 1001);
38 μl of polymer gel precursor were deposited onto the separator;
An electrochemical cell was assembled from the separator (impregnated with the polymer gel precursor); a NMC111 cathode disc having a 13 mm diameter; and a graphite anode disc having a 13 mm diameter;
The polymer gel precursor was cured for 60 minutes in an oven at 55° C., and the cells were then placed in a thermostatic chamber at a constant temperature of 25° C. for 4 hours.

A further cell was prepared following the protocol above, except that liquid electrolyte was deposited onto the separator instead of the polymer gel precursor and the curing step was omitted. This was Comparative Example 3.

The electrochemical cells were cycled using the following protocol: full cycles were conducted at a current value of 0.5C during charge and 1C during discharge, where the value of 1C corresponds to the full capacity of the cell drained/charged in 1 h. Voltage was limited to the region 2.7-4.2V vs Li⁺/Li and no constant voltage steps were added at the end of charge.

The results are shown in FIG. 4, in which the discharge capacities of the cells are shown relative to the discharge capacity achieved during the first cycle of Comparative Example 3. From FIG. 4, it can be seen that the gel polymer electrolyte of Example 2 allows greater retention of capacity than the gel polymer electrolyte of either Comparative Examples 1 or 2.

### Variation of Storage Modulus G′ as a Function of the Extent of Crosslinking

Polymer gel precursors were prepared by mixing the ingredients listed in Table 2.

TABLE 2

| | Example 3 | Example 4 | Example 5 |
|---|---|---|---|
| Liquid | 7.2 g 1M solution of LiTFSI in a carbonate solvent | | |
| electrolyte | | | |
| Monofunctional | 0.43 g Butyl | 0.35 g Butyl | 0.29 g Butyl |
| monomer | acrylate | acrylate | acrylate |
| Crosslinker | 0.12 g | 0.2 g | 0.26 g |
| monomer | Polyethylene | Polyethylene | Polyethylene |
| | glycol | glycol | glycol |
| | diacrylate | diacrylate | diacrylate |
| | (PEGDA) | (PEGDA) | (PEGDA) |
| Polymerisation | 0.005 g Azobisisobutyronitrile (AIBN) | | |
| initiator | | | |

The PEGDA cross-linker monomer had a number-averaged molecular weight (Mn) of 700.

Gels were prepared and their rheology tested as described above in relation to Example 1 and Comparative Examples 1 and 2. The results are shown in FIG. 5, from which it can be seen that Example 3 (which has the lowest crosslink density) has the lowest storage modulus, while Example 5 (which has the highest crosslink density) has the highest storage modulus.

### Variation of Storage Modulus G′ as a Function of Crosslinker Type

Polymer gel precursors were prepared by mixing the ingredients listed in Table 3.

Gels were prepared and their rheology tested as described above in relation to Example 1 and Comparative Examples 1 and 2. The results are shown in FIG. 6.

TABLE 3

| | Example 6 | Example 7 | Example 8 | Example 9 | Example 10 |
|---|---|---|---|---|---|
| Liquid | 7.2 g 1M solution of LiTFSI in a carbonate solvent | | | | |
| electrolyte | | | | | |
| Monofunc- | 0.35 g Butyl | 0.365 g butyl | 0.40 g butyl | 0.44 g butyl | 0.33 g butyl |
| tional | acrylate | acrylate | acrylate | acrylate | acrylate |
| monomer | | | | | |
| Crosslinker | 0.20 g | 0.185 g | 0.15 g | 0.11 g 1,10- | 0.22 g |
| monomer | Polyethylene | Polyethylene- | Bisphenol | Bis(acryloyloxy) | Poly(propylene |
| | glycol | glycol | A ethoxylate | decane | glycol) |
| | diacrylate | dimethacrylate | diacrylate | (BAD) | diacrylate |
| | (PEGDA) | (PEGDMA) | (BPAEDA) | | (PPGDA) |
| Polymeri- | 0.005 g Azobisisobutyronitrile (AIBN) | | | | |
| sation | | | | | |
| initiator | | | | | |

1. A gel polymer electrolyte comprising a polymer matrix and a liquid electrolyte that is trapped and retained within the polymer matrix, wherein the polymer matrix is provided by a copolymer that comprises linear polymer chains having a monofunctional repeating unit and crosslinkers that provide a polymeric cross-linking function between the linear chains.

2. A gel polymer electrolyte according to claim 1, wherein the molar ratio of the monofunctional repeating unit and the crosslinkers lies in the range 50:50 to 99.9:0.1.

3. (canceled)

4. (canceled)

5. A gel polymer electrolyte according to claim 1, wherein a ratio of the total mass of the linear chains having a monofunctional repeating unit and the total mass of the crosslinkers lies in the range 30:70 to 95:5.

6. A gel polymer electrolyte according to claim 1, having a storage modulus G′ of 10-950 Pa at a frequency of 0.1 rad/s.

7. (canceled)

8. A gel polymer electrolyte according to claim 1, wherein the polymer matrix is present in an amount of 1-70 vol % relative to the total volume of the polymer gel electrolyte.

9. A gel polymer electrolyte according to claim 1, wherein the polymer matrix is present in an amount of 1-25 wt % relative to the total mass of the gel polymer electrolyte.

10. (canceled)

11. A gel polymer electrolyte according to claim 1, wherein the polymeric crosslinkers have a molecular weight in the range 170-6000 Mw.

12. (canceled)

13. (canceled)

14. A gel polymer electrolyte according to claim 1, wherein at least 95% by weight of the polymeric crosslinkers have reactive ends selected from the group consisting of acrylic or methacrylic functional groups.

15. A gel polymer electrolyte according to claim 1, wherein at least 95% by weight of the polymeric crosslinkers comprise a main chain and at least two reactive ends, wherein the main chain comprises a unit selected from the group consisting of: alkane, polyethylene oxide (glycol), polypropylene oxide, bisphenol A ethoxylate, and siloxane.

16. (canceled)

17. (canceled)

18. A gel polymer electrolyte according to claim 1, wherein at least 95% by weight of the monofunctional repeating units of the linear polymer chains are acrylate or methacrylate units.

19. A gel polymer electrolyte according to claim 1, wherein the at least 95% by weight of the monofunctional repeating units of the linear polymer chains comprise an alkane chain consisting of 1-8 carbon atoms.

20. (canceled)

21. (canceled)

22. A gel polymer electrolyte according to claim 1, wherein the liquid electrolyte comprises a solution of a lithium, sodium, or magnesium salt and the molar ratio of the salt and the monofunctional repeating unit lies in the range 0.2:1 to 4:1.

23. An electrochemical cell comprising at least an electrode layer and an electrolyte layer disposed on a face of the electrode layer, wherein the electrolyte layer comprises a gel polymer electrolyte according to claim 1.

24. An electrochemical cell according to claim 23, wherein the electrolyte layer further comprises a porous spacer.

25. (canceled)

26. A precursor composition for forming a gel polymer electrolyte according to claim 1, the precursor composition comprising:
a quantity of monofunctional monomers;
a quantity of crosslinker molecules, the crosslinker molecules having at least two reactive ends; and
a liquid electrolyte.

27. A precursor composition according to claim 26 comprising a polymerisation initiator, wherein the polymerisation initiator is a thermal polymerisation initiator.

28. A method of making a gel polymer electrolyte according to claim 1, comprising providing a precursor composition and curing the precursor composition,
wherein the precursor composition comprises:
a quantity of monofunctional monomers;
a quantity of crosslinker molecules, the crosslinker molecules having at least two reactive ends; and
a liquid electrolyte.

29. A method of making an electrochemical cell according to claim 23, comprising the steps of providing a substrate comprising an electrode active material; applying a precursor composition to an exposed surface of the substrate; and curing the precursor composition to provide a gel polymer electrolyte;
wherein the precursor composition comprises:
a quantity of monofunctional monomers;
a quantity of crosslinker molecules, the crosslinker molecules having at least two reactive ends; and
a liquid electrolyte.

30. (canceled)

31. A gel polymer electrolyte according to claim 1, wherein the polymer matrix is present in an amount of 2-40 vol % relative to the total volume of the polymer gel electrolyte.

32. An electrochemical cell according to claim 24, wherein the porous spacer comprises a material selected from the group consisting of: polymeric materials; electrically-insulating materials; and a composite material having a polymeric matrix and additionally comprising ceramic electrolyte particles.

33. A precursor composition for forming a gel polymer electrolyte according to claim 26, further comprising a polymerisation initiator.
